(19) United States
(12) Patent Application Publication
(10) Pub. No.: US 2004/0121792 A1
(43) Pub. Date: Jun. 24, 2004

(54) Multi-protocol network and method of switching protocols

(76) Inventors: Vernon A. Allen, Fort Lauderdale, FL (US); Oleg Andric, West Palm Beach, FL (US); Wayne W. Chiou, Sunrise, FL (US); Ralph L. D'Souza, Sunrise, FL (US); Minh T. Pham, Boynton Beach, FL (US)

Correspondence Address: Barbara R. Doutre, Motorola, Inc., Law Department, 8000 West Sunrise Boulevard, Fort Lauderdale, FL, 33322, US

(21) Appl. No.: 10/324,300

(22) Filed: Dec. 18, 2002

(51) Int. Cl. H04B 7/00; H04Q 7/20

(52) U.S. Cl. 455/519; 455/518; 455/516

(57) ABSTRACT

A multi-routing protocol network (100, 200) and methods (400, 500) of operating wireless devices (102, 104) in the network that allow the network to be switched from one routing protocol to another are provided. Wireless devices initiate communication with devices that are already part of the network, or are starting the network, and transmit information indicative of supported routing protocols. Subsequently the devices receive commands to operate according to particular routing protocols.

### CROSS REFERENCE TO RELATED APPLICATION

This application is related to the application Ser. No. 10/125,939 filed Apr. 19, 2002, entitled “Communication Network Utilizing a Cluster Tree Protocol,” by Maeda et al.; application Ser. No. 09/803,259 filed Mar. 9, 2001, entitled “A Protocol for a Self-Organizing Network Using a Logical Spanning Tree Backbone,” by Lee et al.; and application Docket No. CML00414J entitled “Network Architecture, Addressing and Routing,” by P. Chen et al., filed Nov. 26, 2002, which are hereby incorporated herein by reference and assigned to Motorola, Inc.

### FIELD OF THE INVENTION

The present invention relates in general to networking. More particularly, the present invention relates to ad hoc wireless networking.

### BACKGROUND OF THE INVENTION

Advances in electronics manufacturing technology have enabled the manufacture of inexpensive wireless devices in large quantities. Presently there is an interest in greatly expanding the use of wireless devices and networks of wireless devices beyond traditional communication uses.

Examples of applications of networks of inexpensive wireless devices, include sensor systems that include a large number of spatially distributed sensors, and distributed control systems that include both a large number of spatially distributed sensors, and a large number of spatially distributed actuators. In the former application one or more nodes can serve as data sinks at which data from the sensors is collected, and in the latter application sensors may in some case route data directly to actuators, and also route data to one or more nodes that are linked to data monitoring stations. Examples of distributed control systems include a fire control system for a large facility that includes a plurality of smoke detectors, and a plurality of sprinkler valve actuators.

One type of wireless network that is of interest is that which is termed an ‘ad hoc’ network. In forming an ad hoc network, wireless devices that have been positioned as needed in building or outdoor area, upon being turned on, interoperate in order to form a cohesive network that is able to route messages from one wireless device to another as needed. A variety of routing protocols have been proposed for use in ad hoc wireless device networks. Certain routing protocols are suitable for certain types of applications. For example if much of the communication activity on an ad hoc network involves sending data to and from a particular node e.g., a node acting as a central controller, then a routing protocol based on an organization of the ad hoc network according to a hierarchical tree topology is appropriate. For applications of ad hoc networks which do not require a central node, peer-to-peer routing protocols are appropriate, and can be more efficient for routing messages between nodes. Different routing protocols can be associated with different network topologies. In each case, the network topology determines which wireless devices send messages to each other in operating according to the protocol. The optimum choice of routing protocol and corresponding network topology is application dependent.

It would be desirable to be able to enjoy the performance characteristics of a variety of routing protocols in a single network.

### BRIEF DESCRIPTION OF THE FIGURES

The present invention will be described by way of exemplary embodiments, but not limitations, illustrated in the accompanying drawings in which like references denote similar elements, and in which:

FIG. 1 is a graph showing a hierarchical tree topology wireless communication network of wireless devices in accordance with the present invention;

FIG. 2 is a graph showing a second topology wireless communication network of the wireless devices shown in FIG. 1 in accordance with the present invention;

FIG. 3 is a functional block diagram of a wireless device of the networks shown in FIGS. 1-2 according to the preferred embodiment of the invention;

FIG. 4 is a flow chart of a method of operating a wireless device of the networks shown in FIGS. 1-2 according to the preferred embodiment of the invention;

FIG. 5 is a flow chart of a method of operating a wireless device of the networks shown in FIGS. 1-2 according to the preferred embodiment of the invention; and

FIG. 6 is a hardware block diagram of a wireless device of the networks shown in FIGS. 1-3 according to the preferred embodiment of the invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

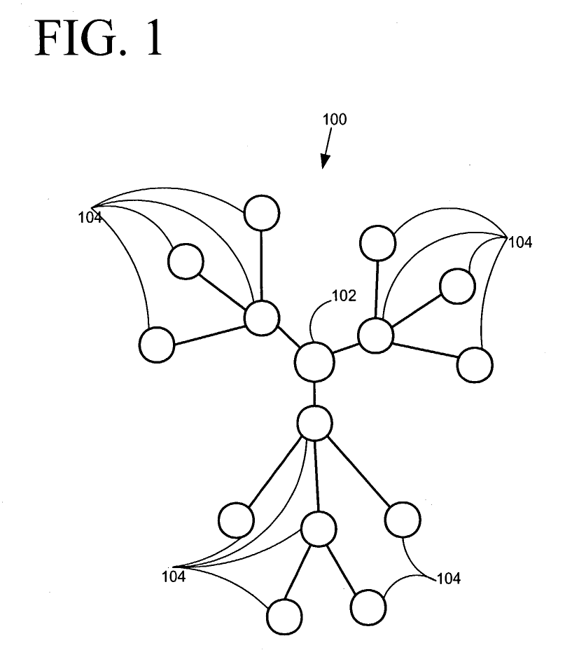

FIG. 1 is a graph showing a hierarchical tree topology 100 wireless communication network in accordance with the present invention. The network includes a central wireless device 102 in a root position of the hierarchical tree topology and a plurality of other wireless devices 104. The central wireless device 102 is distinguished by its position in the network. The central wireless device 102 optionally has increased processing power. On the other hand, the central device 102 is optionally identical in hardware design to other nodes of the network. The edges shown in FIG. 1 represent paths over which messages are routed according to a routing scheme used in the network 102 that is consistent with the hierarchical tree topology.

One routing scheme that is consistent with the hierarchical tree topology is described in co-pending application “Network Architecture, Addressing and Routing” by Priscilla Chen et al. According to the network addressing and routing scheme, described in the latter application each nodes of the network are assigned addresses such that routing decisions can be made based on numerical comparisons that involve the assigned addresses.

Alternatively, routing tables maintained at each wireless device are used in routing messages through the network 100.

Routing protocols that use hierarchical tree topologies are efficient in the case that a large fraction of network traffic includes messages from or to the root position wireless device 102.

Although, the network 100, as shown in FIG. 1 includes only twelve wireless devices 102, 104, more wireless devices can be included in the network. Large networks can be divided into a plurality of sub-trees also referred to as ‘clusters’. Each particular cluster is preferably identified by a cluster address that is common to all wireless devices in the particular cluster. Within each particular cluster specific wireless devices are identified by network addresses.

The edges shown in FIG. 1 represent network layer level connections, i.e., paths over which messages are sent. Depending on the distances between devices, 102, 104, some of the devices 102, 104 that are not shown to be connected by edges will be within range, and aware of devices in addition to those with which logical links are established. Devices may become aware of devices in addition to those with which network layer level connections are maintained via communications at a lower levels of a communication protocol stack. Such lower level connections, allow the network layer level connections to be reconfigured according to other network routing protocols.

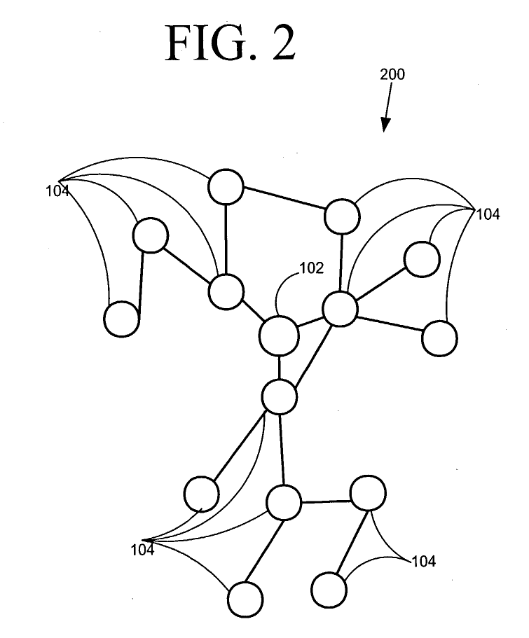

FIG. 2 is a graph showing a peer-to-peer topology wireless communication network 200 of the wireless devices shown in FIG. 1 in accordance with the present intention. Although the peer-to-peer topology includes the same wireless devices 102, 104, as shown in FIG. 1, the topology indicated by the arrangement of edges in FIG. 2 is different. Note that edges corresponding to network layer level connections can in certain routing protocols be dynamic. For example logical layer level connections can be established for each messages to be sent if they do not already exist, and can be expired if not used within a certain period. Examples of non-hierarchical tree topologies, in which logical layer level connections are changeable include ‘Dynamic Source Routing Protocol” and “Ad hoc On-Demand Distance Vector protocol”.

Routing protocols that do not use hierarchical tree topologies can be more efficient when network traffic is not heavily centered on one particular wireless device.

In the case that more than one application is to be run on a single network, it is desirable to be able to optimally choose the routing scheme, and network layer topology of the network for each application.

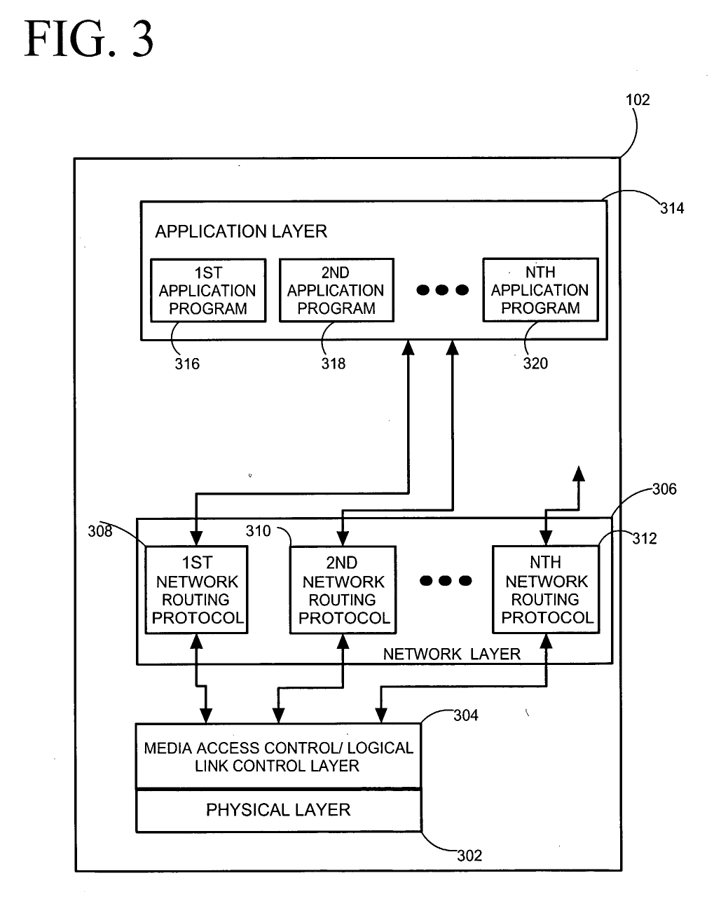

FIG. 3 is a functional block diagram of the wireless device 102 of the networks shown in FIGS. 1-2 according to the preferred embodiment of the invention. The other wireless devices 104 are also preferably described by the same functional block diagram as shown in FIG. 3. A number of the blocks shown in FIG. 3 correspond to layers of the International Organization for Standards Open System Interconnection (ISO/OSI) model. Referring to FIG. 3, a physical layer 302 includes a radio frequency transceiver. A media access control (MAC)/logical link control (LLC) layer 304 is coupled to the physical layer 304. The MAC/LLC layer 304 is in charge of low-level communications. The MAC/LLC layer coordinates the timing of communications. Low-level communications use MAC layer addresses which are preferably factory set and permanently stored in each wireless device 102, 104. Such addresses preferably comprises sixty-four bit IEEE addresses.

A network layer module 306 is coupled to the MAC/ILLC layer 306. The network layer 306 comprises a plurality of different network routing protocol modules 308, 310, 312, including a first network routing protocol module 308, a second network routing protocol module 310, and an nth network routing protocol module 312. The network routing protocol modules 308, 310, 312, preferably comprise at least one routing protocol that is based on a hierarchical tree topology such as shown in FIG. 1, and at least one peer-to-pear routing protocol. The network routing protocol modules preferably support diverse routing protocols such as Dynamic Source Routing (DSR), location/geographic routing, and/or Ad hoc On-demand Distance Vector (AODV) routing. The network layer can also comprises other network layer functionality.

An application layer 314 is coupled to the network layer 306. The application layer 314 comprises a plurality of application programs 316, 318, 320, including a first application program 316, a second application program 318, and a third application program 320. Each application program 316, 318, 320 routes messages through a network (e.g., 100, 200) of which the wireless device 102 is a part. For each application 316, 318, 320 a particular network routing protocol 308, 310, 312 works best. Which routing protocol works best for each application can be determined based on trial and error, or simulation. In certain cases the network routing protocol that is best suited for a particular application will be readily apparent. For example for a sensor network application in which a particular wireless device serves as a data sink, a routing protocol based on a hierarchical tree topology in which the data sink wireless device occupies the root position is appropriate.

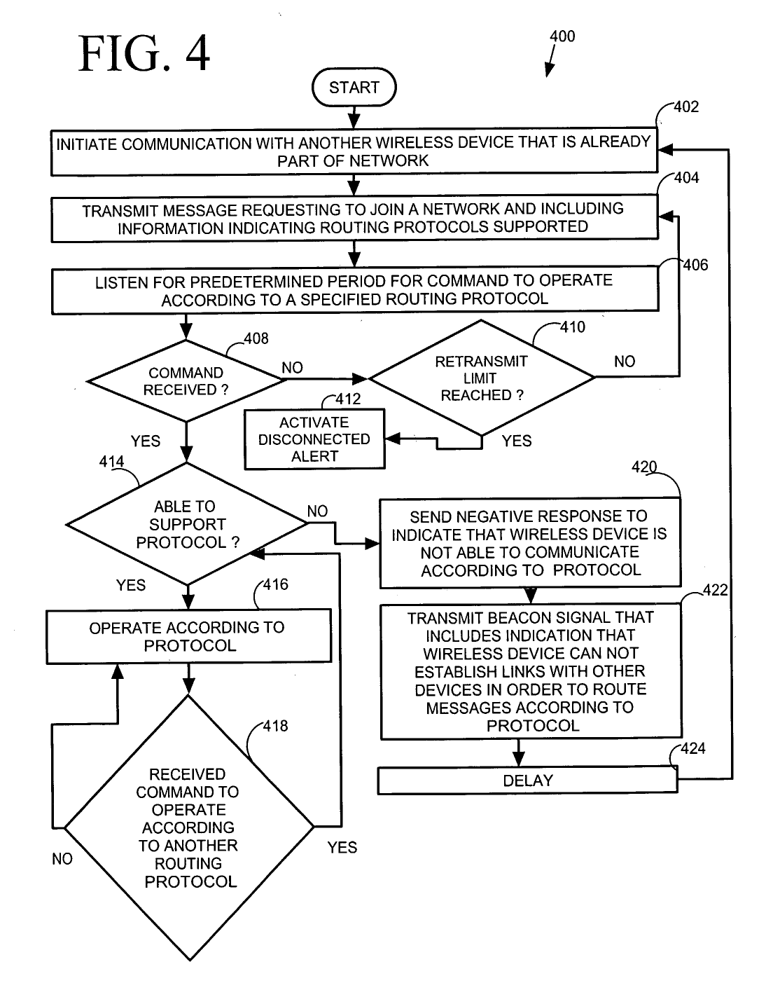

FIG. 4 is a flow chart of a method 400 of operating a wireless device of the networks shown in FIGS. 1-2 according to the preferred embodiment of the invention. The method 400 is shown from the perspective of a particular device hereinafter referred to as the kth device. The method 400 starts prior to the kth device having joined a network (e.g., 100, 200).

In step 402 communication is initiated between the kth device and another device, hereinafter referred to as the ith device, that is already part of the network. The communication can be initiated by the kth device or the ith device. Initiation of communication is preferably based on MAC/LLC layer protocols. Initiation of communication preferably involves transmitting a beacon signal from one device (e.g., the kth device), and listening for a beacon signal (e.g., from the ith device).

In step 404 the kth node transmits a message to or through the ith device requesting to join the network. The message transmitted in step 404 includes or is supplemented by a further message that includes information identifying routing protocols that the kth device supports. Such information preferably takes the form of a set of binary flags each of which specifies whether or not a particular routing protocol is supported. The message sent in step 404 is preferably sent using MAC/LLC layer protocols, e.g., using a physical address, and not assuming a particular routing protocol. The message is sent to or through one or more neighbors of the kth device that are discovered through MAC/LLC layer processes. The message is optionally sent to a device in the network that is responsible for supervisory functions.

In step 406 the kth device listens for a command to operate according to a specified routing protocol for a predetermined period of time. The command is preferably sent in response to the message sent in step 404. Block 408 is a decision block the outcome of which depends on whether a command to operate according to a specified routing protocol was received. If not then the method 400 continues with decision block 410 the outcome of which depends on whether a preprogrammed retransmit limit has been reached. If not the method loops back to step 404 and retransmits the message requesting to join the network. If in step 410 it is determined that the retransmit limit has been reached then the method 410 halts at step 412 in which a disconnected alert of the kth device is activated. The disconnected alert preferably takes the form of a light (e.g., a flashing light), or an audible alarm. The disconnected alert signals that human intervention may be required to trouble shoot network problems and get the kth device connected to the network (e.g. by moving the kth device to a position of higher signal strength).

Preferably, at least initially, the network is operated using a routing protocol that all wireless devices in the network can support. The command received in step 406 can be sent from a wireless device that has supervisory authority for the network, or supervisory authority for a part of the network that includes the kth device, or from a wireless device that is merely a nearest neighbor or parent (in a hierarchical tree topology) of the kth device. According to an alternative embodiment each device is programmed to start operating according to a preprogrammed routing protocol upon being powered on, and need not initially receive a command to operate according to a particular routing protocol.

If in block 408 it is determined that a command to operate according to a specified protocol has been received, then the method 400 continues with decision block 414 the outcome of which depends on whether the kth device is able to support the specified protocol indicated in the command received in block 406. If it is determined in block 414 that the kth device is able to support the specified protocol, the method 400 continues with block 416 in which the kth device operates according to the specified protocol. When operating according to the specified protocol, the kth device preferably periodically transmits a beacon that indicates that the kth device is participating in the network. The beacon indicates that messages can be routed through the kth device (unless the kth device is at a leaf position, in a hierarchical tree topology network).

Thereafter, at any time, while the kth device is operating in the network, a command may be received instructing the kth device to operate according to another routing protocol. For example in the case that, initially the network is operating according to a routing protocol based on a hierarchical tree topology, a command to change to a different routing protocol can be broadcast from a wireless device that is located at the root position. Information used to operate according to a first protocol can be stored when switching to another protocol.

The possibility of receiving a command to operate according to another protocol is reflected in FIG. 4 in block 418 which follows step 416, and is a decision block. The outcome of decision block 418 depends on whether a command to operate according to a new routing protocol is received. If not then the kth device continues to operate according to the protocol according to which it is currently operating.

If on the other hand a command is received instructing the kth device to operate according to a new protocol, then the method 400 loops back to decision block 414.

If on reaching decision block 414, either from decision block 408 or decision block 418, it is determined that the kth device is not able to support the routing protocol according to which it has been requested to operate, then the method 400 continues with step 420. In step 420 a negative response that indicates that the kth device is not able to operate according to the commanded protocol is transmitted. In step 422 a beacon signal that includes an indication that the kth wireless device cannot establish links with other devices in order to route messages according to the commanded protocol is transmitted.

Following block 422 after a predetermined delay 424, the device 402 loops back to step 402. Note that during the delay 424, or after multiple delay 424 periods have elapsed, the network may have been switched to a protocol that the kth device is able to support (as determined in step 414) and the kth device will be able to join or rejoin the network.

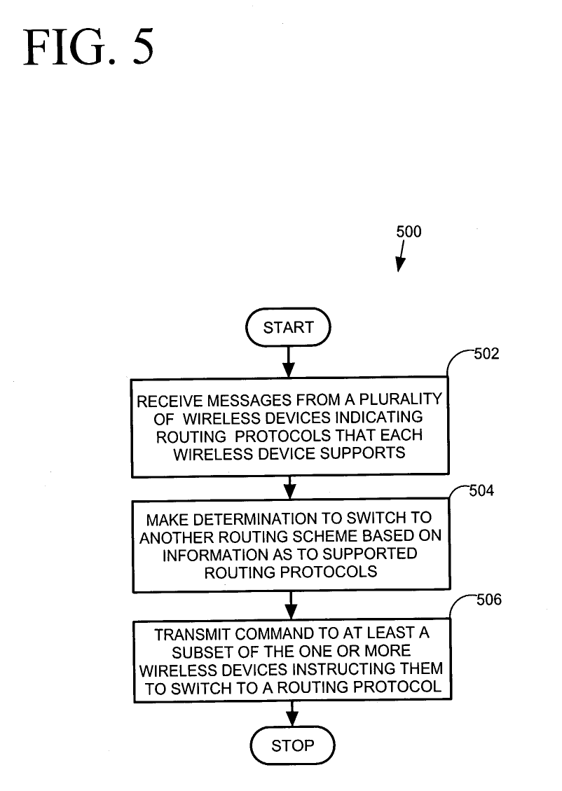

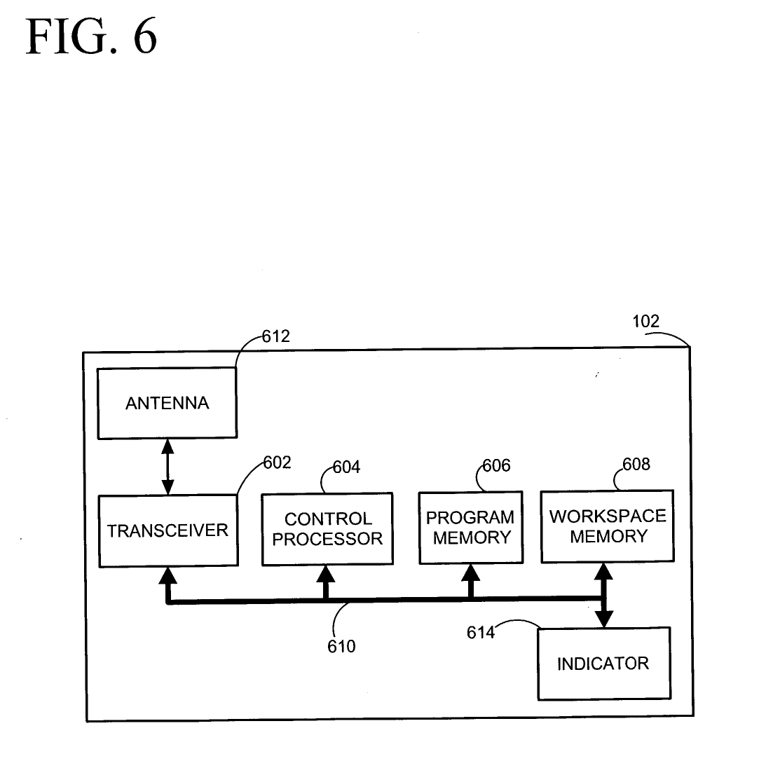

FIG. 5 is a flow chart of a method 500 of operating a wireless device of the networks 100, 200 shown in FIGS. 1-2 according to the preferred embodiment of the invention. The wireless device that executes the method 500 shown in FIG. 6, herein after referred to as the mth wireless device, performs a control function in the networks 100, 200. In particular, in block 502, messages are received from a plurality of wireless devices indicating what routing protocols each of the wireless devices supports. The messages received in step 502 are equivalent to the message sent step 404 of method 400. Alternatively, the messages received in step 502 are sent by an intermediate wireless device (e.g., a wireless device having special status among a subset of the wireless devices of a network) based on information extracted from the message sent in step 404. Step 502, takes place over at least a period of time as wireless devices join the network.

In step 504 a determination to switch to another routing protocol is made based on the information collected in step 502.

In step 506 a command is transmitted to at least a subset of the wireless devices 102, 104 in the network (e.g., 102, 104) to switch to a specified routing protocol. Either the entire network can be commanded to switch to a new routing protocol, or a part of the network can be commanded to switch to a new protocol.

FIG. 6 is a hardware block diagram of the central wireless device 102 that is included in the networks shown in FIGS. 1-2 according to the preferred embodiment of the invention. The other wireless devices 104 preferably have the same basic internal structure. Optionally the wireless devices (e.g., central wireless device 102) that in carrying out certain routing protocols perform more functions (e.g., control functions) are connected to external power sources, and/or have higher processing power. The wireless device 102 comprises a transceiver 602 a processor 604, a program memory 606, a workspace memory 608 and an indicator 614 coupled together through a signal bus 610. The control processor 604 controls the overall operation of the wireless device 102, and is used to execute programs embodying the methods shown in FIG. 4 or 5. The control processor 604 also serves to generate packets for transmission, and process received packets. The program memory 606 is used to store the programs executed by the control processor 604. The program memory 606 is a type of computer readable medium. Programs embodying the method shown in FIGS. 4, 5 are alternatively stored in other types of program memories. The works space memory 608 is used as a workspace by the control processor 604 in executing the programs stored in the program memory 606. The transceiver 602 is coupled to an antenna 612. The indicator 614, which can be audible or visual or both is used to indicate that a wireless device 102 is not connected to the network (e.g., 100, 200) and human intervention may be necessary to get the wireless device 102 connected to the network.

The computer readable medium used in connection with the present invention as a memory for storing programs can comprise volatile memory such as RAM, or a medium that contains data in a transient state, such as a communication channel, network circuits, or a wireless communication link, or preferably nonvolatile memory including but not limited to, flash memory, Read Only Memory (ROM), EPROM, EEPROM, disk drive. The computer readable medium used as a workspace for signal processing operations, can comprise Random Access Memory (RAM). The present invention, as would be known to one of ordinary skill in the art could be produced in hardware or software, or in a combination of hardware and software. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

What is claimed is:

1. A method for operating a wireless device comprising:
transmitting a request to join a network; and
receiving, from the network, a first command to operate according to a first routing protocol among a plurality of routing protocols that are supported by the wireless device.

2. The method according to claim 1 further comprising:
transmitting information identifying the plurality of routing protocols that are supported by the wireless device.

3. The method according to claim 2 wherein:
transmitting information identifying the plurality of routing protocols that are supported by the wireless device comprises:
transmitting a packet including a set of binary flags that indicate whether each of the plurality of protocols are supported.

4. The method according to claim 1 further comprising:
after receiving the first command, determining if the wireless device is capable of supporting the first routing protocol; and
in the case that the wireless device is not capable of supporting the first routing protocol, transmitting at least a message indicating that the wireless device is not capable of supporting the first routing protocol.

5. The method according claim 4 wherein:
transmitting at least the message comprises, transmitting a response to the first command indicating that the wireless device is not capable of supporting the first protocol.

6. The method according to claim 4 wherein:
transmitting at least the message comprises, transmitting a beacon signal that includes information indicating that the wireless device cannot serve as a network member through which other wireless devices route messages.

7. The method according to claim 4 further comprising:
receiving a second command to operate according to a second routing protocol through the network; and %
in the case that the second routing protocol is among the plurality of routing protocols that are supported by the wireless device,
operating according to the second routing protocol.

8. The method according to claim 7 further comprising:
in the case that the second routing protocol is among the plurality of routing protocols that are supported by the wireless device,
transmitting a beacon signal that includes information indicating that the wireless device can serve as a node through which other wireless devices route messages.

9. A method for operating a wireless device in a network comprising:
receiving information identifying one or more routing protocols that each of one or more other wireless devices support from the one or more other wireless devices;
transmitting a command to at least a subset of the one or more wireless devices instructing at least the subset of the one or more wireless devices to operate according to a particular routing protocol.

10. A method of operating a wireless device:
transmitting a first message from the wireless device to initiate a process of the wireless device becoming part of a network, a predetermined number of times;
awaiting receipt of a second message acknowledging the first message; and
in the case that the second message acknowledging the first message is not received, activating an indicator to indicate that the wireless device has been unsuccessful in joining the network.

11. The method according to claim 10 wherein:
transmitting the first message from the wireless device to initiate the process of the wireless device becoming part of the network, the predetermined number of times comprises:
allowing a predetermined period of time for the second message to be received before retransmitting the first message.

12. The method according to claim 10 wherein
transmitting the first message, comprises transmitting information indicating one or more routing protocols that the wireless device supports.

13. A wireless device comprising:
a transceiver;
a processor coupled to the transceiver wherein the processor is programmed to:
transmit a request to join a network; and
receive, from the network, a first command to operate according to a first routing protocol among a plurality of routing protocols that are supported by the wireless device.

14. The wireless device according to claim 13 wherein the processor is further programmed to:
transmit information identifying the plurality of routing protocols that are supported by the wireless device.

15. The wireless device according to claim 14 wherein:
in transmitting information identifying the plurality of routing protocols that are supported by the wireless device the processor programmed to:
transmit a packet including a set of binary flags that indicate whether each of the plurality of routing protocols are supported.

16. The wireless device according to claim 13 wherein the processor is further programmed to:
after receiving the first command, determine if the wireless device is capable of supporting the first routing protocol; and
in the case that the wireless device is not capable of supporting the first routing protocol, transmit at least a message indicating that the wireless device is not capable of supporting the first routing protocol.

17. The wireless device according claim 16 wherein:
in transmitting at least the message, the processor is programmed to transmit a response to the first command indicating that the wireless device is not capable of supporting the first protocol.

18. The wireless device according to claim 16 wherein:
in transmitting at least the message the processor is programmed to, transmit a beacon signal that includes information indicating that the wireless device cannot serve as a network member through which other wireless devices route messages.

19. The wireless device according to claim 16 wherein the processor is further programmed to:
receive a second command to operate according to a second routing protocol through the network; and
in the case that the second routing protocol is among the plurality of routing protocols that are supported by the wireless device,
operate according to the second routing protocol.

20. The wireless device according to claim 19 wherein the processor is further programmed to:
in the case that the second routing protocol is among the plurality of routing protocols that are supported by the wireless device,
transmit a beacon signal that includes information indicating that the wireless device can serve as a node through which other wireless devices route messages.

21. A wireless for use in a network comprising:
a transceiver;
a processor coupled to the transceiver, wherein the processor is programmed to:
receive information identifying one or more routing protocols that each of one or more other wireless devices support from the one or more other wireless devices; and
transmit a command to at least a subset of the one or more wireless devices instructing at least the subset of the one or more wireless devices to operate according to a particular routing protocol.

22. A wireless device comprising:
a transceiver;
a processor coupled to the transceiver wherein the processor is programmed to:
transmit a first message from the wireless device to initiate a process of the wireless device becoming part of a network, a predetermined number of times;
await receipt of a second message acknowledging the first message; and
in the case that the second message acknowledging the first message is not received, activate an indicator to indicate that the wireless device has been unsuccessful in joining the network.

23. The wireless device according to claim 22 wherein:
in transmitting the first message from the wireless device to initiate the process of the wireless device becoming part of the network, the predetermined number of times comprises:
the processor is programmed to allow a predetermined period of time for the second message to be received before retransmitting the first message.

24. The wireless device according to claim 22 wherein:
in transmitting the first message, the processor is programmed to transmit information indicating one or more routing protocols that the wireless device supports.
